(19) United States
(12) Patent Application Publication
(10) Pub. No.: US 2007/0201336 A1
(43) Pub. Date: Aug. 30, 2007

(54) Method And Device For Writing Multiple-Layer Optical Discs

(75) Inventor: Gheorghe Sorin Stan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,462

(22) PCT Filed: Mar. 23, 2005
(86) PCT No.: PCT/IB05/50989

§ 371 Date: Sep. 29, 2006

(30) Foreign Application Priority Data
Apr. 2, 2004 (EP) 04101373.1

(51) Int. Cl. G11B 7/00

(52) U.S. Cl. 369/53.31; 369/94; 369/44.32

(57) ABSTRACT

A method of writing information in a storage layer (2A,2B) of a multi-layer optical storage medium (2) comprising two or more storage layers (2A,2B), especially multi-layer recordable and rewritable optical discs, especially DVD discs or BD discs. The method comprises the steps of monitoring a focus condition of an optical write beam (32b), and inhibiting the writing process in case of an axial focus displacement event. Also described is a medium access device (10), capable of writing information in a storage layer (2A,2B) of a multi-layer optical storage medium (2). The medium access device (10) comprises: light beam generating means (31) for generating a write light beam (32); focussing means (34) for focussing the write (32) in a focal spot (F) at a target storage layer (2A); write inhibit means (64) for inhibiting a writing process in case of an axial focus displacement event.

### FIELD OF THE INVENTION

The present invention relates in general to a method and device for writing information to multiple-layer optical discs.

### BACKGROUND OF THE INVENTION

As is commonly known, an optical storage disc comprises at least one track of storage space, either in the form of a continuous spiral or in the form of multiple concentric circles, where information may be stored in the form of a data pattern. Optical discs are very successful, and several different types have been developed. One such type is DVD (Digital Versatile Disc), and the present invention relates particularly to DVD discs. However, the gist of the present invention is also applicable to other types of optical media like the Blu-ray Disc.

Optical discs may be of the read-only type, in which case they contain information recorded during manufacturing and are read out by users. An optical storage disc may also be of a writeable type, in which case the information is stored by a user. Such discs may be of a write-once type, indicated as recordable (R), but there are also storage discs where information can be written many times, indicated as rewritable (RW). In the case of DVD, a distinction is made between three rewritable formats known as DVD−RW, DVD+RW, and DVD-RAM and two recordable formats known as DVD−R and DVD+R.

For writing information in the storage space of the optical storage disc, a disc drive apparatus comprises a light beam generator, typically a laser, which generates a light beam (laser beam), and optical elements for focusing the laser beam in a focal spot at the storage track. The disc drive apparatus comprises a motor for rotating the disc, and comprises servo systems, particularly a radial servo system and a focus servo system, for controlling the optical elements such that the focused spot follows the track of the rotating disc (radial servo) and such that the laser spot remains at the correct focus depth (focus servo or axial servo). Since the technology of optical discs in general, and the way in which information can be stored in an optical disc are commonly known, it is not necessary here to describe this technology in more detail.

Conventionally, an optical disc has only one storage layer containing one or more data tracks. More recently, optical discs have been developed having two or even more storage layers at a mutual distance of only several micrometers, each storage layer containing the corresponding storage track(s). In such multiple layer optical discs, and in particular for recordable/rewritable optical media, maintaining the correct focus condition is even more important than in the case of single-layer discs: a non-optimal focus condition inherently forms a threat to the neighbouring layer where the existent information may be destroyed unintentionally.

Thus, an important objective of the present invention is to provide a disc drive apparatus for writing multiple-layer optical discs wherein the risk of damage due to focus errors is eliminated or at least reduced.

### SUMMARY OF THE INVENTION

According to an important aspect of the present invention, a disc drive apparatus for writing multiple-layer optical discs comprises means for monitoring a focus condition, and for inhibiting the recording process if an out-of-focus condition threatening a neighbouring layer is found. Thus, although the out-of-focus condition is not prevented, the potentially harmful effect thereof is effectively eliminated.

### BRIEF DESCRIPTION OF THE DRAWINGS

These and other aspects, features and advantages of the present invention will be further explained by the following description with reference to the drawings, in which same reference numerals indicate same or similar parts, and in which:

FIG. 1 schematically illustrates relevant components of an optical disc drive apparatus;

FIG. 2 is a block diagram schematically illustrating a part of the control circuit 90 in more detail;

FIG. 3 is a flow diagram schematically illustrating the operation of a write inhibit circuit;

FIGS. 4A and 4B are graphs illustrating examples of signals useable for indicating a focus displacement event.

### DESCRIPTION OF THE INVENTION

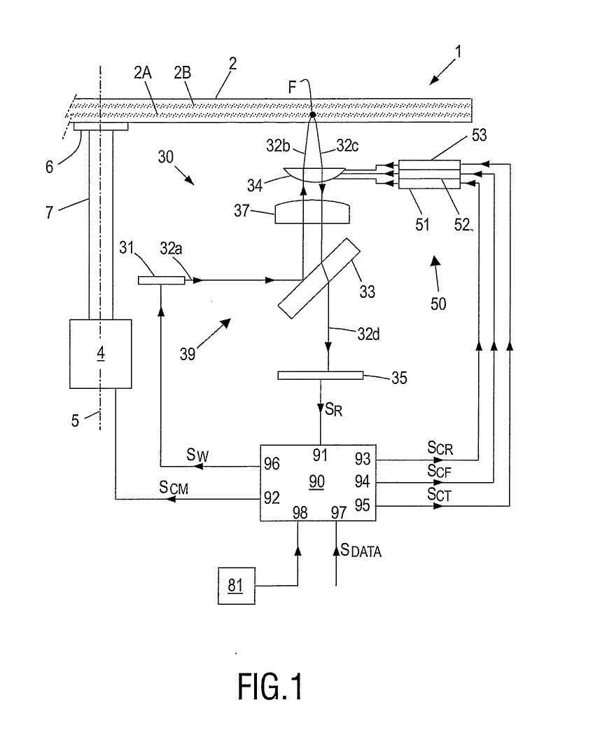

FIG. 1 schematically illustrates an optical disc drive apparatus 1, suitable for storing information on an optical disc 2, typically a DVD or a CD. For rotating the disc 2, the disc drive apparatus 1 comprises a motor 4 fixed to a frame (not shown for the sake of simplicity), defining a rotation axis 5.

In this example, the disc 2, of which the thickness is shown in an exaggerated way, has two storage layers 2A and 2B, but it is noted that the present invention also relates to discs having three or more layers. The phrase “multiple layers” will be used to indicate two or more layers.

The disc drive apparatus 1 further comprises an optical system 30 for scanning tracks (not shown) of the disc 2 by an optical beam. More specifically, in the exemplary arrangement illustrated in FIG. 1, the optical system 30 comprises a light beam generating means 31, typically a laser such as a laser diode, arranged to generate a light beam 32. In the following, different sections of the light beam 32, following an optical path 39, will be indicated by a character a, b, c, etc. added to the reference numeral 32.

The light beam 32 passes a beam splitter 33, a collimator lens 37 and an objective lens 34 to reach (beam 32b) the disc 2. The light beam 32b reflects from the disc 2 (reflected light beam 32c) and passes the objective lens 34, the collimator lens 37 and the beam splitter 33 (beam 32d) to reach an optical detector 35. The objective lens 34 is designed to focus the light beam 32b in a focal spot F on the track of one storage layer (i.e. first storage layer 2A in FIG. 1).

The disc drive apparatus 1 further comprises an actuator system 50, which comprises a radial actuator 51 for radially displacing the objective lens 34 with respect to the disc 2. Since radial actuators are known per se, while the present invention does not relate to the design and functioning of such a radial actuator, it is not necessary here to discuss the design and functioning of a radial actuator in great detail.

For achieving and maintaining a correct tilt position of the objective lens 34, the objective lens 34 may be mounted slantingly; in such a case, as shown, the actuator system 50 also comprises a tilt actuator 53 arranged for pitching the objective lens 34 with respect to the disc 2. Since tilt actuators are known per se, while furthermore the design and operation of such a tilt actuator is no subject of the present invention, it is not necessary here to discuss the design and operation of such a tilt actuator in great detail.

It is further noted that means for supporting the objective lens with respect to an apparatus frame, and means for axially and radially displacing the objective lens, as well as means for pitching the objective lens, are generally known per se. Since the design and operation of such supporting and displacing means are no subject of the present invention, it is not necessary here to discuss their design and operation in great detail.

It is further noted that the radial actuator 51, the focus actuator 52 and the tilt actuator 53 may be implemented as one integrated actuator.

The disc drive apparatus 1 further comprises a control circuit 90 having a first output 92 connected to a control input of the motor 4, having a second output 93 coupled to a control input of the radial actuator 51, having a third output 94 coupled to a control input of the focus actuator 52, having a fourth output 95 coupled to a control input of the tilt actuator 53, and having a fifth output 96 coupled to a control input of the laser device 31. The control circuit 90 is designed to generate at its first output 92 a control signal S_{CM} for controlling the motor 4, to generate at its second control output 93 a control signal S_{CR} for controlling the radial actuator 51, to generate at its third output 94 a control signal S_{CF} for controlling the focus actuator 52, to generate at its fourth output 95 a control signal S_{CT} for controlling the tilt actuator 53, and to generate at its fifth output 96 a control signal S_{W} for controlling the laser.

The control circuit 90 further has a read signal input 91 for receiving a read signal S_{R} from the optical detector 35. The optical detector 35 may actually comprise several individual detector elements, as is known per se, and the read signal S_{R} may actually consist of several individual detector element output signals, as is also known per se. Further, the read signal input 91 may actually comprise several individual input signal terminals, each one receiving a corresponding one of the detector element output signals, as is also known per se.

The control circuit 90 is designed to process individual detector element output signals to derive one or more error signals. A radial error signal, hereinafter simply designated as RE, indicates the radial distance between a track and the focal spot F. A focus error signal, hereinafter simply designated as FE, indicates the axial distance between a storage layer and the focal spot F. It is noted that, depending on the design of the optical detector, different formulas for error signal calculation may be used.

The control circuit 90 is designed to generate its actuator control signals as a function of the error signals, to reduce the corresponding error, as will be clear to a person skilled in the art.

The control circuit 90 further comprises a laser control output 96 and a data input 97. In a read mode, the intensity of the laser beam 32 is kept substantially constant, and variations in intensity of the individual detector element output signals received at the read signal input 91 reflect the data content of the track being read. In a write mode, the control circuit 90 generates a control signal S_{W} for the laser 31 on the basis of a data signal S_{DATA} received at its data input 97, so that the laser beam intensity fluctuates for writing a pattern corresponding to the input data. Distinct intensity levels are also used for erasing a rewritable disc, which may take place while overwriting the existing data or as a stand-alone process that blanks the disc.

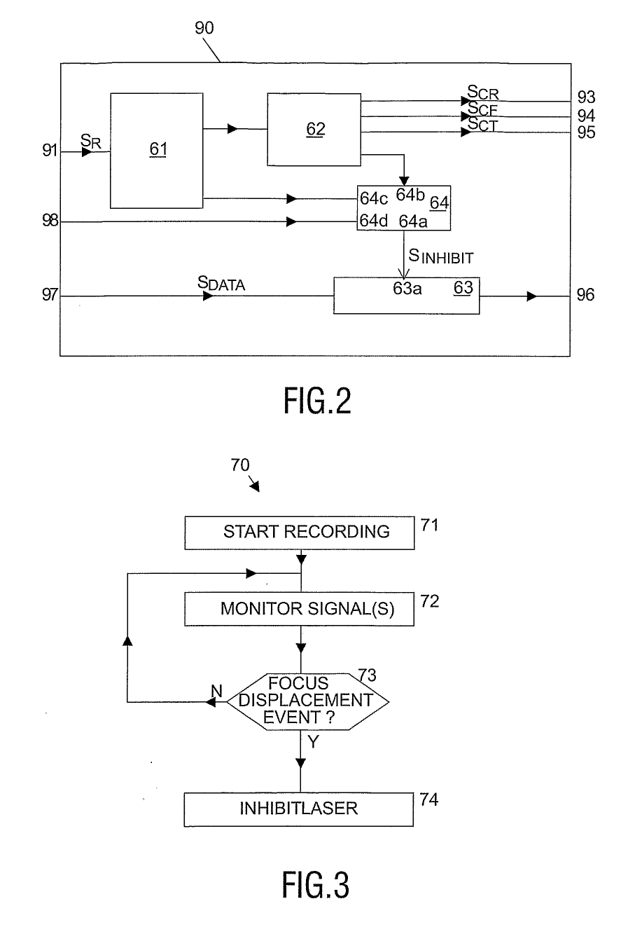

FIG. 2 is a block diagram schematically illustrating a part of the control circuit 90 in more detail. The control circuit 90 comprises a signal preprocessing circuit 61, which receives the read signal S_{R} from the read signal input 91. A servo processor 62 receives output signals from the signal preprocessing circuit 61, and generates the actuator control signals S_{CR}, S_{CF}, S_{CT} at outputs 93, 94, 95, respectively.

The control circuit 90 further comprises a laser driver circuit 63, which receives the data signal S_{DATA} from the data input 97, and generates the laser control signal S_{W} at laser control output 96.

The control circuit 90 further comprises a write inhibit circuit 64, which has an inhibit output 64a coupled to a control input 63a of the laser driver circuit 63. The write inhibit circuit 64 is designed to generate a control signal S_{INHIBIT} for the laser driver circuit 63 on the basis of input signals, as will be described later.

The operation process 70 of the write inhibit circuit 64 will be described with reference to the flow diagram of FIG. 3. After the start of recording [step 71], the write inhibit circuit 64 monitors [step 72] one or more of its input signals, received at one or more of its inputs 64b, 64c, 64d, respectively, and examines [step 73] whether one or more of the monitored signals indicate the occurrence of an axial focus displacement event. By the phrase “axial focus displacement event” is meant an axial displacement of the focus spot F, with respect to the target storage layer location, over a distance large enough to endanger the integrity of a neighbouring layer.

This examination step may involve calculating the size of the axial displacement and comparing this axial displacement with a threshold distance. Depending on the mutual distance of storage layers, such a threshold distance may have different values.

The examination step may also involve the step of detecting whether the laser beam is focussed at the wrong storage layer, for instance by detecting a transition from the correct storage layer to another storage layer, for instance by detecting a characteristic feature of an input signal. This embodiment has the advantage that the focus displacement distance does not have to be calculated, and that it is not necessary to define any threshold distance, yet has the disadvantage, with respect to the previous embodiment, that a detection result is only obtained after the focus spot has actually reached a neighbouring layer. In the case of calculating the focus displacement distance and comparing it with a threshold distance, an advantage is that action can be taken before a neighbouring layer is actually damaged.

As long as such input signals indicate that no focus displacement event has occurred, i.e. that the location of the focus spot F is at the correct layer 2A, 2B, the write inhibit circuit 64 will allow the laser driver circuit 63 to operate as usual, and data is written to the disc as normal. The operation of the write inhibit circuit 64 continues with step 72.

If the occurrence of a focus displacement event is detected, the write inhibit circuit 64 generates its control signal S_{INHIBIT} for the laser driver circuit 63 such as to inhibit the laser driver circuit 63 [step 74]. The recording process is halted.

In this situation, it is possible that an error message is presented to the user, and that the recording process is only resumed after an action taken by the user (such as entering a reset command). Typically, however, the error message is presented only to the microprocessor or microcontroller controlling the behaviour of the optical disc system. After receiving the error message, the microprocessor or microcontroller instructs the circuit 90 to refocus the laser beam onto the correct layer and to resume the writing process from the point where it had been interrupted. Then, the operation of the write inhibit circuit 64 continues with step 71.

As a safety measure, it is possible that the laser driver circuit 63 responds to the control signal S_{INHIBIT} by switching off the laser beam completely. It is, however, sufficient if the laser driver circuit 63 responds by reducing the laser power of the laser beam to a sufficiently low level, for instance below a predefined safety level, so that the recording process is halted and damage to already written data is effectively avoided. Then, the refocusing operation can be executed with reduced laser power.

If the laser driver circuit 63 responds to the control signal S_{INHIBIT} by switching off the laser beam completely, then executing a refocusing operation requires the said microprocessor or microcontroller to send an instruction to the laser driver circuit 63 to switch on the laser beam, at reduced power, thus effectively overriding the switch-off instruction by the inhibit signal.

Anyway, it is noted that the present invention relates to detecting any displacement events and to stopping the recording process in response, as a safety measure. Actions taken as from this moment are no subject of the present invention.

As regards the input signals for the write inhibit circuit 64, the present invention may be implemented in different ways.

In one embodiment, the disc drive 1 may comprise a vibration sensor or acceleration sensor 81, mounted at a suitable location. Since vibration/acceleration sensors are known per se, it is not necessary here to explain their design and operation in detail. In such a case, the control circuit 90 may have an input 98 for receiving an output signal from the vibration/acceleration sensor 81, which input is coupled to an input 64d of the write inhibit circuit 64. Output signals from the vibration/acceleration sensor 81 may indicate the occurrence of a shock of such strength that a focus displacement event is likely to happen.

In another embodiment, the write inhibit circuit 64 may receive input signals derived from the optical read signal SR received at input 91. For instance, the write inhibit circuit 64 may have an input 64c coupled to a first output 61 a of the preprocessing circuit 61, receiving from the preprocessing circuit 61 a signal S_{CA} corresponding to the reflected central aperture signal obtained from a forward-sense diode (not shown for the sake of simplicity) of the sensor 35.

In another example, the write inhibit circuit 64 may have an input 64b coupled to a first output 62a of the servo processor 62, receiving from the servo processor 62 a signal S_{FE} corresponding to the focal error signal FE.

In another example, the write inhibit circuit 64 may receive at this input 64b a signal S_{FEI} corresponding to the focal error signal FE integrated with a predetermined time constant.

It is noted that the write inhibit circuit 64 may receive any one of the above-mentioned signals, or another suitable signal. However, it is also possible that the write inhibit circuit 64 receives two or more such signals, and is designed to examine these input signals in correlation with each other, such that the write inhibit circuit 64 only decides that a focus displacement event has occurred (or is occurring) if two or more of the monitored signals indicate the occurrence of a focus displacement event in a correlated way.

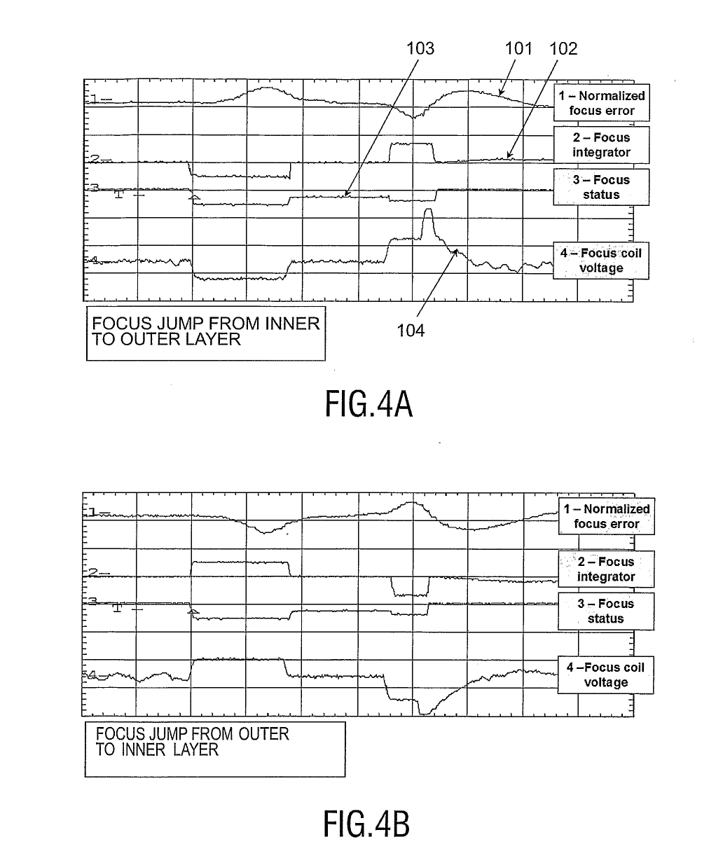

FIGS. 4A and 4B are graphs illustrating the behaviour of some of the internal signals of the control circuit 90 in the case of a transition of the focus spot from one storage layer to a neighbouring layer; FIG. 4A relates to the case of a transition to a layer located further away from the laser (corresponding to an upward displacement of the focus spot F in FIG. 1), and FIG. 4B relates to the opposite situation. When comparing these two graphs, it can be seen that the corresponding curves have similar shapes, possibly inverted sign. Therefore, in the following only FIG. 4A will be discussed in detail.

Curve 101 shows the behaviour of the normalized focus error signal FEN when the spot moves from the innermost layer where it was in focus to the outer layer. In this case the FEN signal first exhibits a bump that indicates that focus has been lost and that the focus point has moved away from the inner information layer. Subsequently, the FEN signal will exhibit a decrease in amplitude and cross the zero reference level, after which it increases again and stabilizes itself close to said zero level. This behaviour is usually called the S-curve and denotes the acquisition of the information layer at the correct focus point. The S-curve can only be observed during a controlled focus acquisition, and in this particular case the focus point approaches the outer information layer and remains there under closed-loop control. When the focus is lost due to whatever cause and the control system does not intervene (open-loop control), the FEN signal remains flat after the bulk previously mentioned.

Curve 102 shows the behaviour of the accumulated (integrated) error inside the loop regulator. Curve 103 shows the behaviour of the binary status of the focus error falling within a given range around zero. Curve 104 shows the behaviour of the control voltage applied to the actuator coil. The signals plotted in FIG. 4A are typical of focus loops in optical disk drives and the associated timing should be related to 150-200 microseconds per division.

If the focus is lost due to whatever cause, several signals may be used to detect this situation. In the typical example illustrated in FIG. 4A, the normalized focus error 101, the accumulated error 102 inside the loop integrator, or the voltage 104 across the focus coil show abrupt changes that can be used for out-of-focus detection. Other signals that can be used may come from the radial tracking loop or from the readout channel.

It should be clear to a person skilled in the art that the present invention is not limited to the exemplary embodiments discussed above, but that several variations and modifications are possible within the protective scope of the invention as defined in the appending claims.

For instance, it is possible that the write inhibit circuit 64 inhibits the writing process if only one of its input signals indicates the occurrence of an axial focus displacement event. It is also possible that the write inhibit circuit 64 inhibits the writing process only if two or more of its input signals indicate the occurrence of an axial focus displacement event in a time-correlated way.

Apart from detecting that an axial focus displacement event is actually occurring, it is also possible to predict that an axial focus displacement event is about to occur, and to inhibit the writing process in advance. For instance, it is possible to measure and evaluate the time-evolution (first or higher time derivative) of the deviation of the focus point, and to predict the value of this deviation by extrapolation. It is also possible to decide that an axial focus displacement event is likely to occur in the near future if the focus point displacement speed (or a time-derivative of a monitoring signal) exceeds a predetermined speed level.

Thus, the method proposed by the present invention implies not only the detection of any signal amplitudes exceeding given thresholds, either any one alone or two or more simultaneously, but may also imply the measurement of the acceleration with which the focus point is lost by evaluating the speed with which monitored signals change in time.

In the above, the invention has been explained for the case of a disc having two storage layers. However, the gist of the present invention is also applicable in the case of multiple layers.

In the above, the present invention has been explained with reference to block diagrams, which illustrate functional blocks of the device according to the present invention. It is to be understood that one or more of these functional blocks may be implemented in hardware, where the function of such a functional block is performed by individual hardware components, but it is also possible that one or more of these functional blocks are implemented in software, so that the function of such a functional block is performed by one or more program lines of a computer program or a programmable device such as a microprocessor, microcontroller, digital signal processor, etc.

1. Method of writing information in a storage layer (2A, 2B) of a multi-layer optical storage medium (2) comprising two or more storage layers (2A, 2B), the method comprising:
monitoring a focus condition of an optical write beam (32b);
inhibiting the writing process in case of an axial focus displacement event.

2. Medium access device (10), capable of writing information in a storage layer (2A, 2B) of a multi-layer optical storage medium (2) comprising two or more storage layers (2A, 2B);
the medium access device (10) comprising:
light beam generating means (31) for generating a write light beam (32);
focussing means (34) for focussing the write light beam (32) in a focal spot (F) at a target storage layer (2A);
write inhibit means (64) for inhibiting a writing process in case of an axial focus displacement event.

3. Medium access device according to claim 2, further comprising a driver circuit (63) for driving the light beam generating means (31) in accordance with a data signal (S_{DATA}) representing data to be written, the driver circuit (63) having a control input (63a); wherein the write inhibit means (64) have an output (64a) coupled to said control input (63a) of the driver circuit (63), the write inhibit means (64) being designed to generate a command signal (S_{INHIBIT}) for the driver circuit (63) such as to effectively inhibit the driver circuit (63) in case of an axial focus displacement event.

4. Medium access device according to claim 2, wherein the write inhibit means (64) has at least one input (64b, 64c, 64d) for receiving at least one input signal capable of indicating an axial focus displacement;
the write inhibit means (64) being designed to monitor at least one of its input signals and to inhibit the writing process if at least one of the input signals is indicative of the occurrence of an axial focus displacement event.

5. Medium access device according to claim 2, wherein the write inhibit means (64) has at least one input (64b, 64c, 64d) for receiving at least one input signal capable of indicating an axial focus displacement;
the write inhibit means (64) being designed to monitor at least two of its input signals and to inhibit the writing process if at least two of the input signals are indicative in a correlated way of the occurrence of an axial focus displacement event.

6. Medium access device according to claim 2, wherein the write inhibit means (64) has at least one input (64b, 64c, 64d) for receiving at least one input signal capable of indicating an axial focus displacement;
the write inhibit means (64) being designed to monitor an input signal, to calculate an axial focus displacement from the input signal, and to decide that the input signal is indicative of an axial focus displacement event if the calculated axial focus displacement exceeds a predetermined displacement threshold.

7. Medium access device according to claim 2, wherein the write inhibit means (64) has at least one input (64b, 64c, 64d) for receiving at least one input signal capable of indicating an axial focus displacement;
the write inhibit means (64) being designed to monitor an input signal, to monitor for the possible occurrence of a predefined characteristic feature of the input signal, and to decide that the input signal is indicative of an axial focus displacement event if such characteristic feature occurs.

8. Medium access device according to claim 2, wherein the write inhibit means (64) has at least one input (64b, 64c, 64d) for receiving at least one input signal capable of indicating an axial focus displacement;
the write inhibit means (64) being designed to monitor at least one of its input signals, to determine the speed with which said at least one of its input signals changes in time (first or higher time-derivative), and to decide that the input signal indicates that an axial focus displacement event is about to occur on the basis of an evaluation of such changes.

9. Medium access device according to claim 8, the write inhibit means (64) being designed to inhibit the writing process if the time-derivative of said at least one of its input signals predicts an axial focus displacement event, i.e. even before the axial focus displacement event actually occurs.

10. Medium access device according to claim 4, further comprising at least one vibration/acceleration sensor (81);
the write inhibit means (64) being designed to monitor at least an output signal from the at least one vibration/acceleration sensor (81).

11. Medium access device according to claim 4, further comprising at least one optical detector (35) for receiving light (32d) reflected from the storage medium (2);
the write inhibit means (64) being designed to monitor at least one signal derived from at least one detector output signal.

12. Medium access device according to claim 11, the write inhibit means (64) being designed to monitor at least a signal (S_{CA}) corresponding to the reflected central aperture signal obtained from a forward-sense diode of the sensor (35), or to monitor at least a signal (S_{FE}) corresponding to the focal error signal (FE), or to monitor at least a signal (S_{FEI}) corresponding to the focal error signal (FE) integrated with a predetermined time constant.

13. Medium access device according to claim 2, capable of handling multi-layer optical discs, especially DVD-discs or BD discs.
